(19) United States
(12) Patent Application Publication
(10) Pub. No.: US 2006/0227874 A1
(43) Pub. Date: Oct. 12, 2006

(54) System, method, and apparatus for DC coefficient transformation

(76) Inventors: Anand Tongle, Bangalore (IN); Bhaskar Sherigar, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/092,256

(22) Filed: Mar. 29, 2005

(51) Int. Cl. H04N 11/04; G06F 17/14; H04N 7/12; H04B 1/66; H04N 11/02

(52) U.S. Cl. 375/240.18; 708/400

(57) ABSTRACT

Presented herein are systems, methods, and apparatus for DC coefficient transformations. In one embodiment, there is presented a circuit for transforming a data matrix. The circuit comprises a controller and a plurality of stages. The controller fetches a row or column of elements from the data matrix. The plurality stages are associated with a plurality of elements in a product matrix and add or subtract each element of the row or column of elements to a plurality of running totals, wherein each of the plurality of elements in the product matrix are a function of the element.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The Hadamard transformation is used to transform a matrix of data. A first matrix is multiplied by a data matrix, yielding a product matrix. The product matrix is then multiplied by a second matrix, resulting in the Hadamard transformed matrix. The Hadamard transformed matrix is inverse transformed by multiplying the first matrix by the Hadamard transformed matrix. The product is then multiplied by the second matrix, resulting in the data matrix.

The Hadamard transformation is used for a variety of applications, including, for example, video compression. For example, in the ITU-H.264 (also known as Advanced Video Coding, and MPEG-4, Part 10, and now referred to as H.264), DC coefficients of frequency transformed pixel data form DC coefficient matrices. The DC coefficient matrices are transformed using the Hadamard transformation during transmission. During decoding, the Hadamard transformed DC coefficient matrices are inverse transformed to the DC coefficient matrices.

The Hadamard transformed matrix elements may be stored in a memory. Performance of the foregoing operations may involve fetching various ones of the matrix elements for calculations of the product matrix and the DC matrix. For an N×N data matrix, as many as 2N³ fetches may be needed for inversing the Hadamard transformation. This is particularly disadvantageous where real time operation is desired.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are systems, methods, and apparatus for DC coefficient transformations.

In one embodiment, there is presented a circuit for transforming a data matrix. The circuit comprises a controller and a plurality of stages. The controller fetches a row or column of elements from the data matrix. The plurality of stages are associated with a plurality of elements in a product matrix and add or subtract each element of the row or column of elements to a plurality of running totals, wherein each of the plurality of elements in the product matrix are a function of the element.

In another embodiment, there is presented a video encoder for encoding video data. The video encoder comprises a memory and a transformation engine. The memory stores a data matrix. The transformation engine Hadamard transforms the data matrix, making no more than one fetch for each element in the data matrix from the memory during the Hadamard transformation.

In another embodiment, there is presented a video decoder for decoding video data. The video decoder comprises a memory and an inverse transformation engine. The memory stores a data matrix. The inverse transformation engine inverse Hadamard transforms the data matrix, making no more than one fetch for each element in the data matrix from the memory during said inverse Hadamard transformation.

In another embodiment, there is presented a method for inverse Hadamard or Hadamard transforming a data matrix. The method comprises fetching each element of a row or column of the data matrix; adding or subtracting each element of the row or column of the data matrix to a plurality of running totals, wherein each of the running totals are associated with particular elements of a product matrix, and wherein each particular element of the product matrix is a function of at least one of the elements of the row or column of the data matrix; and storing the running totals after adding or subtracting each element of the data matrix.

These and other features and advantages of the present invention may be appreciated from a review of the following detailed description of the present invention along with the accompanying figures.

### BRIEF DESCRIPTION OF SEVERAL VIEWS OF THE DRAWINGS

FIG. 1 is a block diagram of an exemplary circuit for calculating the Hadamard transformation or inverse Hadamard transformation in accordance with an embodiment of the present invention;

FIG. 2 is a flow diagram for calculating the Hadamard transformation or inverse Hadamard transformation in accordance with an embodiment of the present invention;

FIG. 3 is a block diagram of an exemplary frame;

FIG. 4A is a block diagram describing spatially predicted macroblocks;

FIG. 4B is a block diagram describing temporally predicted macroblocks;

FIG. 5 is a block diagram describing the encoding of a prediction error;

FIG. 6 is a block diagram describing the grouping of frequency coefficients;

FIG. 7 is a block diagram of an exemplary video encoder in accordance with an embodiment of the present invention; and

FIG. 8 is a block diagram of an exemplary video decoder in accordance with an embodiment of the present invention.

### DETAILED DESCRIPTION OF THE INVENTION

The 4×4 and 2×2 Hadamard transformations are described below:

$$A ⨯ D ⨯ B$$

$$F = [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] [ \begin{matrix}{D}_{00} & {D}_{01} & {D}_{02} & {D}_{03} \\ {D}_{10} & {D}_{11} & {D}_{12} & {D}_{13} \\ {D}_{20} & {D}_{21} & {D}_{22} & {D}_{23} \\ {D}_{30} & {D}_{31} & {D}_{32} & {D}_{33}\end{matrix} ] [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ]$$

$$F = [ \begin{matrix}1 & 1 \\ 1 & - 1\end{matrix} ] [ \begin{matrix}{D}_{00} & {D}_{01} \\ {D}_{10} & {D}_{11}\end{matrix} ] [ \begin{matrix}1 & 1 \\ 1 & - 1\end{matrix} ]$$

where D is the data matrix, and F is the Hadamard transformed matrix.

Additionally, the Hadamard transform is inversed by reapplying the Hadamard transform, i.e., applying the Hadamard transformation to F.

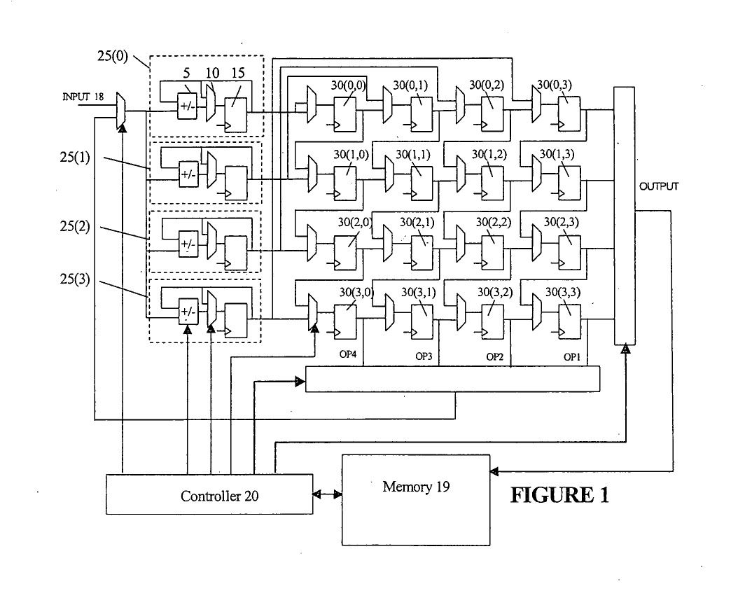

Referring now to FIG. 1, there is illustrated a block diagram describing an exemplary Hadamard transform circuit in accordance with an embodiment of the present invention. The Hadamard transform circuit can either apply the Hadamard transform to a matrix or inverse a Hadamard transformed matrix.

The circuit comprises adder/subtractors 5, multiplexers 10, and accumulators 15 for accumulating elements of a product matrix. The adder/subtractor 5 receives as input, the output of the accumulator 15 and a circuit input 18. The adder/subtractors 5 are controlled by a controller 20. Based on an input provided by the controller 20 to the adder/subtractor 5, the adder/subtractor 5 can either add or subtract the circuit input 18 from the output of the accumulator 15. The result of the adder/subtractors 5 are then stored in the accumulator 15.

Each adder/subtractor 5, multiplexer 10, and accumulator 15 stage 25(0) . . . 25(3) can perform combinations of additions or subtractions for any number of circuit inputs 18. Thus the circuit at input 18 can serially receive D₀₀, D₀₁, D₀₂, D₀₃, as inputs. For example, the controller 20 can fetch the foregoing from a memory 19 storing the data matrix. The top adder/subtractor 5, multiplexer 10, and accumulator 15 stage can calculate D₀₀−D₀₁+D₀₂−D₀₃ and the bottom adder/subtractor 5, multiplexer 10, and accumulator 15 can calculate D₀₀_{_{—}}+D₀₁+D₀₂+D₀₃ The controller 20 can send signals to the adder/subtractor 5, causing the adder/subtractor 5 to add each successive input 18.

Similarly, the controller 20 can fetch the remaining elements of the data matrix D and can control the adder/subtractors 5 for stages 25(1) . . . 25(3), to calculate D₀₀−D₁₀−D₂₀+D₃₀, D₀₀+D₁₀−D₂₀−D₃₀, and D₀₀+D₁₀+D₂₀+D₃₀, respectively. After the foregoing calculations are performed, the accumulators 15 of stages 25(0) . . . 25(3), store the first row of the product matrix DXB. The contents of the accumulators 15 of stages 25(0) . . . 25(3) are shifted to a first column of registers 30(0,0), 30(1,0), 30(2,0), and 30(3,0).

The circuit at input 18 can then serially receive D₁₀, D₁₁, D₁₂, D₁₃, as inputs. The stages 25(0) . . . 25(3), with adder/subtractors 5 controlled by controller 20 can calculate the elements of the second column of the product matrix DXB, and store them in accumulators 15. The contents of the first column of registers 30(0,0), 30(3,0), can then be shifted to the second column of registers 30(0,1), . . . , 30(3,1). The contents of the accumulators 15 can then be shifted to the first column of registers 30(0,0), . . . , 30(3,0).

In the foregoing manner, the third and fourth columns of the product matrix DXB can be calculated and stored. Thus, the first column of registers 30(0,0) . . . 30(3,0) stores the last row of the product matrix DXB, the second column of registers 30(0,1) . . . 30(3,1) stores the third row, the third column of registers 30(0,2) . . . 30(3,2) stores the second row, and the fourth column of registers 30(0,3) . . . 30(3,3) stores the first row.

The elements of the product matrix DXB will now be referred to with the following notation:

$$[ \begin{matrix}{P}_{00} & {P}_{01} & {P}_{02} & {P}_{03} \\ {P}_{10} & {P}_{11} & {P}_{12} & {P}_{13} \\ {P}_{20} & {P}_{21} & {P}_{22} & {P}_{23} \\ {P}_{30} & {P}_{31} & {P}_{32} & {P}_{33}\end{matrix} ]$$

The inputs, P₃₀, P₃₁, P₃₂, P₃₃, can then be serially inputted at input 32 to the circuit from the bottom row of registers 30(3,0) . . . 30(3,3). The controller 20 can control the adder/subtractors 5 for stages 25(0) . . . 25(3), to calculate P₃₀−P₃₁+P₃₂−P₃₃, P₃₀+P₃₁−P₃₂−P₃₃, P₃₀−P₃₁−P₃₂+P₃₃, and P₃₀+P₃₁+P₃₂+P₃₃, respectively. After the foregoing calculations are performed, the accumulators 15 of stages 25(0) . . . 25(3), store the first column of the product matrix A×DXB. The contents of each row of registers 30(0,0) . . . 30(0,3), 30(1,0) . . . 30(1,3), 30(2,0) . . . 30(2,3) are shifted downwards to registers 30(1,0) . . . 30(1,3), 30(2,0) . . . 30(2,3), and 30(3,0) . . . 30(3,3), respectively. The contents of the accumulators 15 of stages 25(0) . . . 25(3) are shifted to a first row of registers 30(0,0), 30(0,1), 30(0,2), and 30(0,3). Accordingly, the first row of registers 30(0,0), 30(0,1), 30(0,2), and 30(0,3) contain first column of matrix P×C, F.

The foregoing can be repeated for each of the remaining rows of the matrix P×B. The first row of registers 30(0,0), 30(0,1), 30(0,2), and 30(0,3) will store the last column of the matrix F. The second row of the registers 30(1,0), 30(1,1), 30(1,2), and 30(1,3) will store the third column of the matrix F. The third row of registers 30(2,0), 30(2,1), 30(2,2), and 30(2,3) will store the second column of the matrix F. The fourth row of registers 30(3,0), 30(3,1), 30(3,2), and 30(3,3) will store the first column of the matrix F.

The columns of registers 30(0,0), . . . ,30(3,0), 30(0,1), . . . ,30(3,1), 30(0,2), . . . , 30(3,2), and 30(0,3), . . . , 30(3,3), store the last, third, second and first row of matrix F. Accordingly, the matrix F is serially shifted out from left to right and by serially shifting out the contents of the last column of registers 30(0,3) . . . 30(3,3), starting from register 30(3,3). The controller 20 can write the matrix F to the memory 19.

According to certain embodiments of the present invention, the circuit performs the Hadamard transformation or inverse transformation for a data matrix with one memory 19 fetch for each element of the data matrix, and one memory 19 write for each element.

In the case of the 2×2 transformation, two stages, e.g., 25(2), 25(3), and 2×2 registers, e.g., 30(2,0), 30(2,1), 30(3,0), and 30(3,1) & 3(0,2), 3(0,3), 3(1,2), 3(1,3) can be used, as shown surrounded by the dotted line.

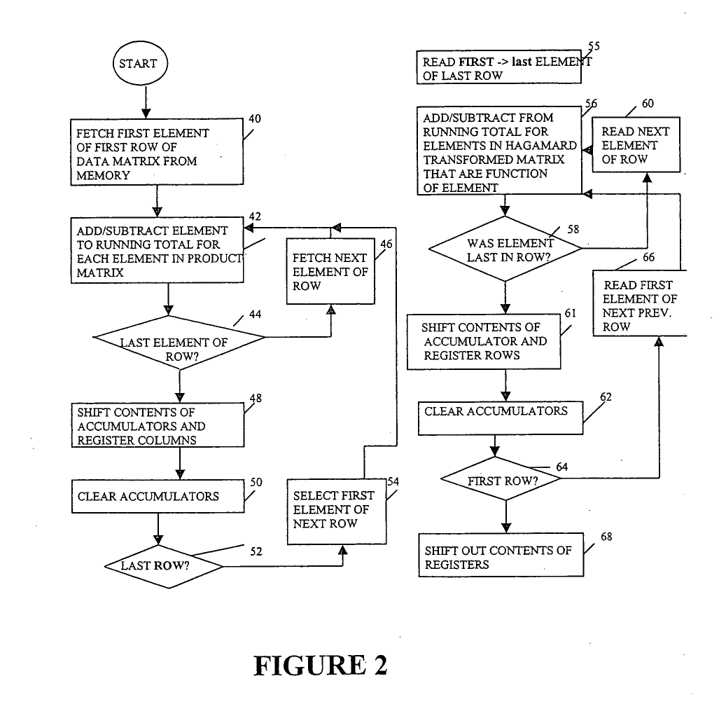

Referring now to FIG. 2, there is illustrated a flow diagram for calculating the Hadamard transformation of a matrix or the inverse Hadamard transformation of the matrix. At 40, the controller 20 fetches the first element of the first row of the data matrix from the memory 19. At 42, the stages 25(0) . . . 25(3) add or subtract the element to a running total for each element in the product matrix that is a function of the element fetched. At 44, a determination is made whether the element fetched was the last element of the row. If not, at 46, the next element of the row is fetched and 42 is repeated.

If the element fetched was the last element of the row at 44, at 48 the contents of the accumulators 15 and the contents of the registers columns 30(x,0) . . . 30(x,2) are shifted to the register columns 30(x,0) . . . 30(x,3). At 50, the accumulators 15 are cleared. At 52, a determination is made whether the row is the last row of the data matrix. If at 52, the row is not the last row of the data matrix, at 54 the first element of the next row is selected, and 42 is repeated.

If at 52, the row is the last row of the data matrix, the registers 30 store each element of the product matrix DXB, or P, wherein the registers 30(3,0) . . . 30(3,3) stored elements P₃₃, P₃₂, P₃₁, and P₃₀, respectively. At 55, the last element of the last row is read from the accumulator 30(3,3). At 56, the element is added or subtracted from the accumulators 15 storing a running total for each element in the Hadamard transformed matrix that is a function of the element. At 58, a determination is made whether the element fetched was the last element of the row. If not, at 60, the next element of the row is read and 56 is repeated.

If the element fetched was the last element of the row at 58, at 61 the contents of the accumulators 15 and the contents of the register rows 30(0,x) . . . 30(2,x) are shifted to the register rows 30(0,x) . . . 30(3,x). At 62, the accumulators 15 are cleared. At 64, a determination is made whether the row is the first row of the product matrix P. If at 64, the row is not the first row of the product matrix, at 66, the first element of the next previous row is selected, and 56 is repeated.

If at 64, the row is the first row of the product matrix, the registers 30 store all of the elements of the Hadamard transformed (or inverse Hadamard transformed) matrix. The contents of the registers 30 are shifted out at 68, starting with the first row 30(0,x) and proceeding to the last row 30(3,x).

The foregoing can be used in a variety of applications utilizing the Hadamard transformation. For example, the video compression standard, ITU-H.264 (also known Advanced Video Coding and MPEG-4, Part 10), now referred to as H.264, uses the Hadamard transformation. According to certain aspects of the present invention, the encoding and decoding according to the H.264 standard can use the foregoing for the Hadamard transformation and inverse Hadamard transformation.

Discussion will now turn to description of the H.264 standard, followed by exemplary video encoders and decoders, in accordance with embodiments of the present invention.

H.264 Standard

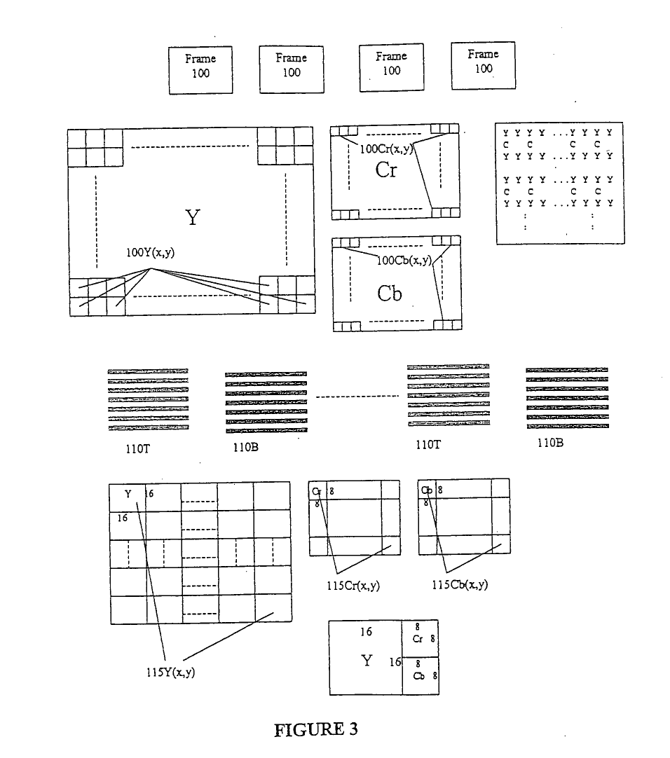

Referring now to FIG. 3, there is illustrated a block diagram of a picture 100. A video camera captures picture 100 from a field of view during time periods known as frame durations. The successive frames 100 form a video sequence. A picture 100 comprises two-dimensional grid(s) of pixels 100(x,y).

For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the MPEG 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

If the video camera is interlaced, the video camera captures the even-numbered lines 100Y(2x,y), 100Cr(2x,y), and 100Cb(2x,y) during half of the frame duration (a field duration), and the odd-numbered lines 100Y(2x+1,y), 100Cr(2x+1,y), and 100Cb(2x+1,y) during the other half of the frame duration. The even numbered lines 100Y(2x,y), 100Cr(2x,y), and 100Cb(2x,y) what is known as a top field 110T, while odd-numbered lines 100Y(2x+1,y), 100Cr(2x+1,y), and 100Cb(2x+1,y) form what is known as the bottom field 110B. The top field 110T and bottom field 110T are also two dimensional grid(s) of luma 110YT(x,y), chroma red 110CrT(x,y), and chroma blue 110CbT(x,y) pixels.

A luma pixels of the frame 100Y(x,y), or top/bottom fields 110YT/B(x,y) can be divided into 16×16 pixel 100Y(16x−>16x+15, 16y->16y+15) blocks 115Y(x,y). For each block of luma pixels 115Y(x,y), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups 122.

The ITU-H.264 Standard (H.264), also known as MPEG-4, Part 10, and Advanced Video Coding, encodes video on a frame by frame basis, and encodes frames on a macroblock by macroblock basis. H.264 specifies the use of spatial prediction, temporal prediction, DCT transformation, interlaced coding, and lossless entropy coding to compress the macroblocks 120.

Spatial Prediction

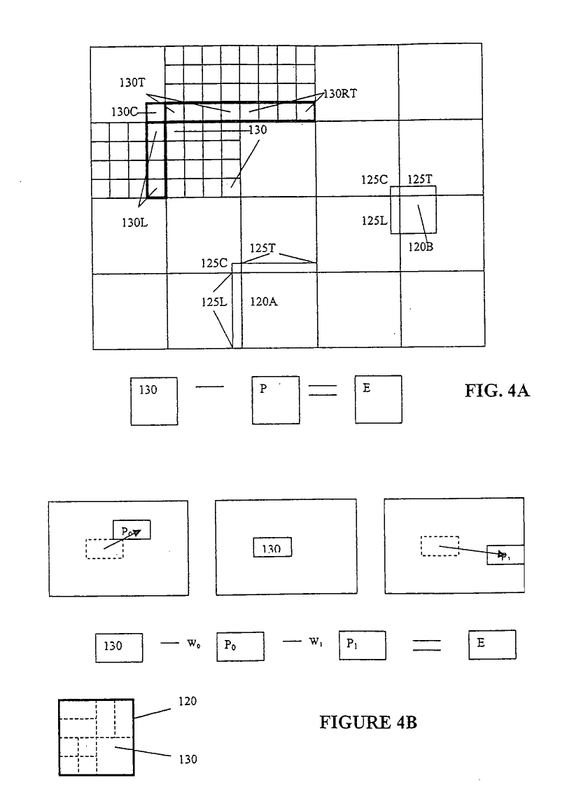

Referring now to FIG. 4A, there is illustrated a block diagram describing spatially encoded macroblocks 120. Spatial prediction, also referred to as intraprediction, involves prediction of frame pixels from neighboring pixels. The pixels of a macroblock 120 can be predicted, either in a 16×16 mode, an 8×8 mode, or a 4×4 mode.

In the 16×16 and 8×8 modes, e.g, macroblock 120a, and 120b, respectively, the pixels of the macroblock are predicted from a combination of left edge pixels 125L, a corner pixel 125C, and top edge pixels 125T. The difference between the macroblock 120a and prediction pixels P is known as the prediction error E. The prediction error E is calculated and encoded along with an identification of the prediction pixels P and prediction mode, as will be described.

In the 4×4 mode, the macroblock 120c is divided into 4×4 partitions 130. The 4×4 partitions 130 of the macroblock 120a are predicted from a combination of left edge partitions 130L, a corner partition 130C, right edge partitions 130R, and top right partitions 130TR. The difference between the macroblock 120a and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

Referring now to FIG. 4B, there is illustrated a block diagram describing temporally encoded macroblocks 120. The temporally encoded macroblocks 120 can be divided into 16×8, 8×16, 8×8, 4×8, 8×4, and 4×4 partitions 130. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the partition 130 and the prediction pixels P. The motion vectors MV can, themselves, be predicted from neighboring partitions.

The partition can also be predicted from blocks of pixels P in more than one field/frame. In bi-directional coding, the partition 130 can be predicted from two weighted blocks of pixels, P0 and P1. Accordingly, a prediction error E is calculated as the difference between the weighted average of the prediction blocks w0P0+w1P1 and the partition 130. The prediction error E, an identification of the prediction blocks P0, P1 are encoded. The prediction blocks P0 and P1 are identified by motion vectors MV.

The weights w0, w1 can also be encoded explicitly, or implied from an identification of the field/frame containing the prediction blocks P0 and P1. The weights w0, w1 can be implied from the distance between the frames/fields containing the prediction blocks P0 and P1 and the frame/field containing the partition 130. Where T0 is the number of frame/field durations between the frame/field containing P0 and the frame/field containing the partition, and T1 is the number of frame/field durations for P1,
w0=1−T0/(T0+T1)
w=1−T1/(T0+T1)
Transformation, Quantization, and Scanning

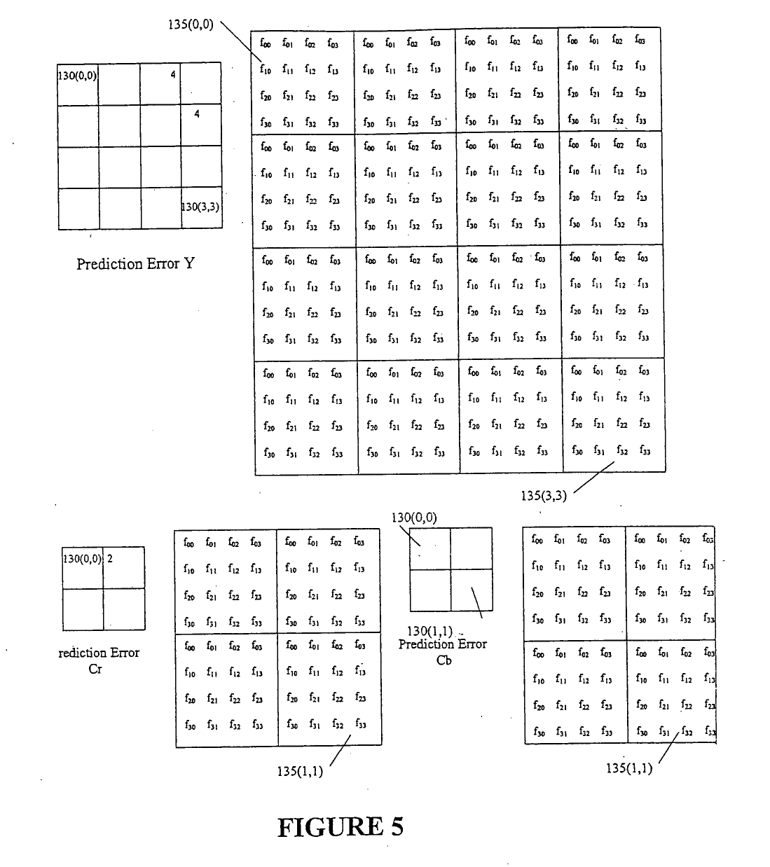

Referring now to FIG. 5, there is illustrated a block diagram describing the encoding of the prediction error E. With both spatial prediction and temporal prediction, the macroblock 120 is represented by a prediction error E. The prediction error E is also two-dimensional grid of pixel values for the luma Y, chroma red Cr, and chroma blue Cb components with the same dimensions as the macroblock 120.

A transformation transforms 4×4 partitions 130(0,0) . . . 130(3,3) for the luma Y prediction error E, 4×4 partitions 130(0,0) . . . 130(1,1) for the chroma red Cr prediction error E, and 4×4 partitions 130(0,0) . . . 130(1,1) chroma blue Cb prediction error E to the frequency domain, thereby resulting in corresponding sets 135(0,0) . . . 135(3,3) of frequency coefficients F₀₀ . . . F₃₃ for the luma Y prediction error, and sets 135(0,0) . . . 135(1,1) for the chroma red Cr, and chroma blue Cb prediction error.

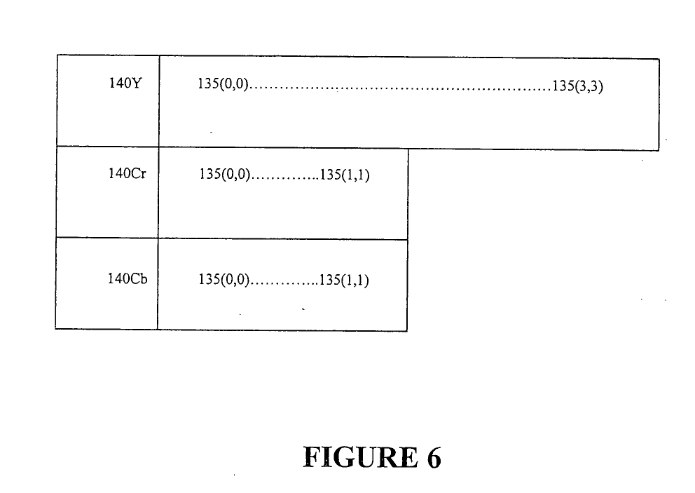

Referring now to FIG. 6, the frequency coefficient F₀₀ of each set of frequency coefficients is known as the DC coefficient. The DC coefficients F₀₀ for each of the sets 135(0,0) . . . 135(3,3) for the luma Y prediction error are grouped together forming a 4×4 luma DC coefficient matrix 140Y. The DC coefficients F₀₀ for each of the sets 135(0,0) . . . 135(1,1) for the chroma red Cr prediction error are grouped together forming a 2×2 chroma red DC coefficient matrix 140Cr. The DC coefficients F₀₀ for each of the sets 135(0,0) . . . 135(1,1) for the chroma blue Cb prediction error are grouped together forming a 2×2 chroma blue DC coefficient matrix 140Cb.

The DC coefficient matrices 140Y, 140Cr, and 140Cb are then transformed using the Hadamard transformation. The Hadamard transformation is as shown below.

The resulting Hadamard transformed DC coefficient matrix 145Y is transmitted along with the remaining frequency coefficients F₀₁ . . . F₃₃ for each of the sets 135(0,0) . . . 135(3,3) representing the luma prediction error Y. The resulting Hadamard transformed DC coefficient matrix 145Cr is transmitted along with the remaining frequency coefficients F₀₁ . . . F₃₃ for each of the sets 135(0,0) . . . 135(1,1) representing the chroma red prediction error Cr. The resulting Hadamard transformed DC coefficient matrix 145Cb is transmitted along with the remaining frequency coefficients F₀₁ . . . F₃₃ for each of the sets 135(0,0) . . . 135(1,1) representing the chroma blue prediction error Cb.

The Hadamard transformed DC coefficient matrices 145Y, 145Cr, 145Cb, and the sets of the frequency coefficients F₀₁ . . . F₃₃ for each of the sets 135(0,0) . . . 135(3,3), 135(0,0) . . . 135(1,1), 135(0,0) . . . 135(1,1) representing the prediction error for the luma, chroma blue, and chroma red pixels are quantized and form a macroblock 120. Each picture 100 is encoded as a set of macroblocks 120. The pictures 100 form the video data. Additionally, the video data can be coded using a variable length code, such Context Adaptive Binary Arithmetic Coding (CABAC) or Context Adaptive Variable Length Coding (CAVLC).

An exemplary encoder and decoder for encoding video data and decoding video data will now be described.

Video Encoder

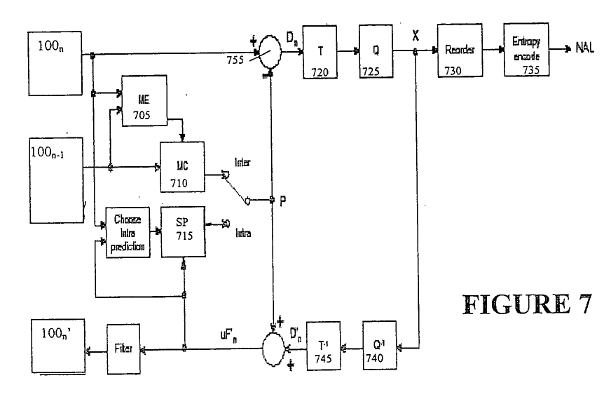

Referring now to FIG. 7, there is illustrated a block diagram describing an exemplary video encoder in accordance with an embodiment of the present invention. The video encoder encodes video data comprising a set of pictures 100. The video encoder comprises motion estimators 705, motion compensators 710, spatial predictors 715, transformation engine 720, quantizer 725, scanner 730, entropy encoders 735, inverse quantizer 740, inverse transformation engine 745, and memory 750. The foregoing can comprise hardware accelerator units under the control of a CPU.

When an input picture 1001n is presented for encoding, the video encoder processes the picture 1001 in units of macroblocks 120. The video encoder can encode each macroblock 120 using either spatial or temporal prediction. In each case, the video encoder forms a prediction block P. In spatial prediction mode, the spatial predictors 715 form the prediction macroblock P from samples of the current frame loon that was previously encoded. In temporal prediction mode, the motion estimators 705 and motion compensators 710 form a prediction macroblock P from one or more reference frames. Additionally, the motion estimators 705 and motion compensators 710 provide motion vectors identifying the prediction block. The motion vectors can also be predicted from motion vectors of neighboring macroblocks.

A subtractor 755 subtracts the prediction macroblock P from the macroblock in picture loon, resulting in a prediction error E. Transformation engine 720 and quantizer 725 block transform and quantize the prediction error E, resulting in a set of quantized transform coefficients X. The scanner 730 reorders the quantized transform coefficients X. The entropy encoders 735 entropy encode the coefficients.

The video encoder also decodes the quantized transform coefficients X, via inverse transformation engine 745, and inverse quantizer 740, in order to reconstruct the picture 100ₙ for encoding of later macroblocks, either within picture 100ₙ or other pictures.

According to certain aspects of the present invention, the transformation engine 720 and inverse transformation engine 745 can incorporate the circuit described in FIG. 1, or the effectuate the flow diagram described in FIG. 2 for Hadamard transforming or inverse Hadamard transforming the DC coefficients. The DC offset matrix can be stored in memory 750.

According to certain aspects of the present invention, the transformation engine 720 or inverse transformation engine 745 makes only one fetch for each element in the DC coefficient matrix and Hadamard transforms or inverse Hadamard transforms the DC coefficient matrix.

Video Decoder

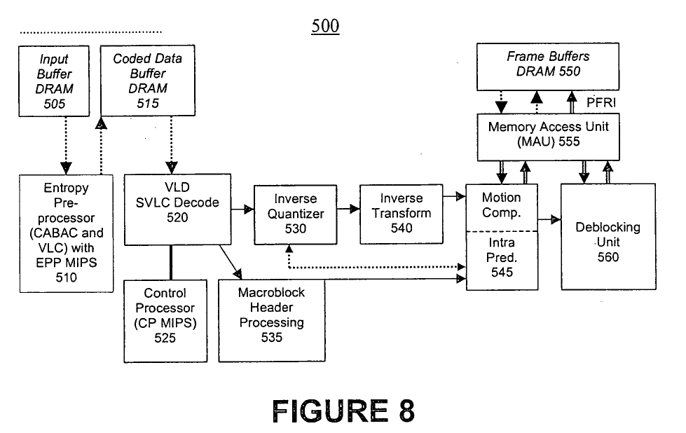

Referring now to FIG. 8, there is illustrated a block diagram describing an exemplary video decoder system 500 in accordance with an embodiment of the present invention. The video decoder 500 comprises an input buffer DRAM 505, an entropy pre-processor 510, a coded data buffer DRAM 515, a variable length code decoder 520, a control processor 525, an inverse quantizer 530, a macroblock header processor 535, an inverse transformer 540, a motion compensator and intrapicture predictor 545, frame buffers 550, a memory access unit 555, and a deblocker 560.

The input buffer DRAM 505, entropy pre-processor 510, coded data buffer DRAM 515, and variable length code decoder 520 together decode the variable length coding associated with the video data, resulting in pictures 100 represented by macroblocks 120.

The inverse quantizer 530 inverse quantizes the macroblocks 120, resulting in the Hadamard transformed DC coefficient matrices 145Y, 145Cr, 145Cb, and the sets of the frequency coefficients F₀₁ . . . F₃₃ for each of the sets 135(0,0) . . . 135(3,3), 135(0,0) . . . 135(1,1), 135(0,0) . . . 135(1,1) representing the prediction error for the luma, chroma blue, and chroma red pixels. The macroblock header processor 535 examines side information, such as parameters that are encoded with the macroblocks 120.

The inverse transformer 540 transforms the frequency coefficients F₀₀ . . . F₃₃ for each of the sets 135(0,0) . . . 135(3,3), 135(0,0) . . . 135(1,1), 135(0,0) . . . 135(1,1), thereby resulting in the prediction error. The motion compensator and intrapicture predictor 545 decodes the macroblock 120 pixels from the prediction error. The decoded macroblocks 120 are stored in frame buffers 550 using the memory access unit 555. A deblocker 560 is used to deblock adjacent macroblocks 120.

The inverse transformer 540 inverses the Hadamard transformed of matrices 145Y, 145Cr, and 145Cb, to generates the DC matrices 140Y, 140Cr, and 140Cb. The DC matrices 140Y, 140Cr, and 140Cb, and the remaining frequency coefficients are converted to the pixel domain. The inverse transformer 540 can comprise the circuit described in FIG. 1 or effectuate the flow diagram of FIG. 2 for inverse transforming the Hadamard transformed matrices 145Y, 145Cr, and 145Cb. The DC offset matrix can be stored in memory 750.

According to certain aspects of the present invention, the transformation engine 720 or inverse transformation engine 745 makes only one fetch for each element in the DC coefficient matrix and Hadamard transforms or inverse Hadamard transforms the DC coefficient matrix.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor. In one representative embodiment, the encoder or decoder can be implemented as a single integrated circuit (i.e., a single chip design).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. For example, although the embodiments have been described with a particular emphasis on the H.264 standard, the teachings of the present invention can be applied to many other standards without departing from it scope. Therefore, it is intended that the present invention not be limited to the particular embodiment disclosed, but that the present invention will include all embodiments falling within the scope of the appended claims.

1. A circuit for transforming a data matrix, said circuit comprising:
a controller for fetching a row or column of elements from the data matrix; and
a plurality of stages associated with plurality of elements in a product matrix for adding or subtracting each element of the row or column of elements to a plurality of running totals, wherein each of the plurality of elements in the product matrix are a function of the element.

2. The circuit of claim 1, further comprising:
a first plurality of registers, for storing contents of the accumulators; and wherein
the controller fetches another row or column of elements from the data matrix; and
the plurality of stages are associated with another plurality of elements in the product matrix and add or subtract each of the elements of the another row or column of elements to a running total associated with another plurality of elements in the product matrix.

3. The circuit of claim 1, wherein the stages comprise:
an adder/subtractor for adding or subtracting each of the element of the row or column of elements to the running total, thereby resulting in a new running total; and
an accumulator for providing the running total to the adder/subtractor and storing the new running total.

4. The circuit of claim 3, further comprising:
a controller for providing a signal to the adder/subtractor, wherein if the signal is a first type, the adder/subtractor adds and wherein if the signal is a first type of signal, the adder/subtractor subtracts.

5. A video encoder for encoding video data, said video encoder comprising:
a memory for storing a data matrix; and
a transformation engine for Hadamard transforming the data matrix, said transformation engine making no more than one fetch for each element in the data matrix from the memory during the Hadamard transformation.

6. The video encoder of claim 5, wherein the transformation engine further comprises:
a controller for fetching a row or column of elements from the data matrix; and
a plurality of stages associated with plurality of elements in a product matrix for adding or subtracting each element of the row or column of elements to a plurality of running totals, wherein each of the plurality of elements in the product matrix are a function of the element.

7. The video encoder of claim 6, wherein the transformation engine further comprises:
a first plurality of registers, for storing contents of the accumulators; and wherein
the controller fetches another row or column of elements from the data matrix; and
the plurality of stages are associated with another plurality of elements in the product matrix and add or subtract each of the elements of the another row or column of elements to a running total associated with another plurality of elements in the product matrix.

8. The video encoder of claim 6, wherein the stages comprise:
an adder/subtractor for adding or subtracting each of the element of the row or column of elements to the running total, thereby resulting in a new running total; and
an accumulator for providing the running total to the adder/subtractor and storing the new running total.

9. The video encoder of claim 8, wherein the transformation engine further comprises:
a controller for providing a signal to the adder/subtractor, wherein if the signal is a first type, the adder/subtractor adds and wherein if the signal is a first type of signal, the adder/subtractor subtracts.

10. The video encoder of claim 5, wherein the memory stores a Hadamard transformed matrix, said video encoder further comprising:
an inverse transformation engine for inverse Hadamard transforming the Hadamard transformed matrix, said inverse transformation engine making no more than one fetch for each element in the data matrix from the memory during the inverse Hadamard transformation.

11. A video decoder for decoding video data, said video decoder comprising:
a memory for storing a data matrix; and
an inverse transformation engine for inverse Hadamard transforming the data matrix, said inverse transformation engine making no more than one fetch for each element in the data matrix from the memory during said inverse Hadamard transformation.

12. The video decoder of claim 11, wherein the inverse transformation engine further comprises:
a controller for fetching a row or column of elements from the data matrix; and
a plurality of stages associated with plurality of elements in a product matrix for adding or subtracting each element of the row or column of elements to a plurality of running totals, wherein each of the plurality of elements in the product matrix are a function of the element.

13. The video decoder of claim 12, wherein the inverse transformation engine further comprises:
a first plurality of registers, for storing contents of the accumulators; and wherein
the controller fetches another row or column of elements from the data matrix; and
the plurality of stages are associated with another plurality of elements in the product matrix and add or subtract each of the elements of the another row or column of elements to a running total associated with another plurality of elements in the product matrix.

14. The video decoder of claim 12, wherein the stages comprise:
an adder/subtractor for adding or subtracting each of the element of the row or column of elements to the running total, thereby resulting in a new running total; and
an accumulator for providing the running total to the adder/subtractor and storing the new running total.

15. The video decoder of claim 14, wherein the inverse transformation engine further comprises:
a controller for providing a signal to the adder/subtractor, wherein if the signal is a first type, the adder/subtractor adds and wherein if the signal is a first type of signal, the adder/subtractor subtracts.

16. A method for inverse Hadamard or Hadamard transforming a data matrix, said method comprising:
fetching each element of a row or column of the data matrix;
adding or subtracting each element of the row or column of the data matrix to a plurality of running totals, wherein each of the running totals are associated with particular elements of a product matrix, and wherein each particular element of the product matrix is a function of at least one of the elements of the row or column of the data matrix; and
storing the running totals after adding or subtracting each element of the data matrix.

17. The method of claim 16, wherein the data matrix comprises a 4×4 matrix.

18. The method of claim 16, further comprising:
fetching each element of another row or column of the data matrix;
adding or subtracting each element of the another row or column to another plurality of running totals, wherein each of the running totals are associated with other particular elements of the product matrix, and wherein each of the other particular elements are functions of at least one element of the another row or column of the data matrix.
